(19) United States
(12) Patent Application Publication
(10) Pub. No.: US 2006/0056629 A1
(43) Pub. Date: Mar. 16, 2006

(54) Asynchronous communication system

(76) Inventors: Anthony Adamson, Redhill (GB); George S Fleming, Romsey (GB)

Correspondence Address: PHILIPS INTELLECTUAL PROPERTY & STANDARDS, P.O. BOX 3001, BRIARCLIFF MANOR, NY, 10510, US

(21) Appl. No.: 10/534,477

(22) PCT Filed: Nov. 5, 2003
(86) PCT No.: PCT/IB03/04992

§ 371 Date: May 10, 2005

(30) Foreign Application Priority Data
Nov. 15, 2002 (GB) 0226661.7

(51) Int. Cl. H04K 1/00

(52) U.S. Cl. 380/255

(57) ABSTRACT

A data storage system, and associated asynchronous communication system and method are described. The data storage system includes data storage means (46) for storing data and an asynchronous transmitter/receiver (45) arranged to communicate over an IEEE 1394 network (30). The data storage means (46) is arranged to accept inputs and to output via an access limiting connector. At least selected data files of the stored data include copy control limiting information, a request for a data file including the copy control limiting information from the data storage means being permitted by the access limiting connector only upon successful authentication. A permitted requested file being encrypted and transmitted asynchronously by the transmitter/receiver (45).

The present invention relates to an asynchronous communication system incorporating copy control and is particularly applicable to the secure transfer of MP3 files and the like.

The digital convergence of PCs and consumer electronics (CE) devices holds enormous promise for the industry. It also poses immediate challenges. The mere prospect of hundreds of millions of dollars in copyrighted content being pirated is enough to limit issue of content in the digital domain. Indeed, some companies have developed technologies that prevent content being transferred to the digital domain. Examples include CDs designed to be unreadable in CD-ROM drives whilst still being playable in HiFis to prevent the ripping of the audio data on them. Various systems exist which create errors on the CD, which are corrected in HiFi CD players, but make the disk unreadable in CD-ROM drives.

Other than creating ill-feeling with users, one potential problem is that these systems restrict people from recording music for private, noncommercial uses and may contravene laws allowing home recordal and/or transfer of the data to another medium.

In order to address this, many suggestions that allow legal copying/movement of digital content data have been made.

Some existing suggestions seek to store data encrypted on a device, so that only the originator would be able to retrieve the file. However, for the MP3 player this would not be desirable as not only would the MP3 player have to decrypt every time it played a file, producing problems when jumping forwards/backwards whilst playing, but it would also have to locally store the decryption keys for each file, presenting another overhead and possible source of weakness in the security of the system.

The Digital Transmission Licensing Authority (DTLA) have proposed a content protection system for the IEEE 1394 bus specification dealing with isochronous transmissions. The system provides content protection so that copyrighted and other valuable content can be protected from unauthorized copying during isochronous transmission. The system specification is called the Digital Transmission Control Protocol (DTCP) and is incorporated herein by reference.

Providing secure isochronous communications is important because all nodes on the network have access to the data being transmitted and so could take additional copies. In contrast to asynchronous transmissions where the identity (or at least some identifier) of the transmitter and receiver is known by both parties, implementations of isochronous transmissions typically take the form of a broadcast where identity of the sink (receiving) device may not necessarily be known by the source (transmitting) device.

Content data is typically transmitted over IEEE 1394 bus as isochronous transmissions whilst control data is transmitted using asynchronous control packets. In order to provide the necessary content protection, the DTCP requires that isochronous transmissions are encrypted using a symmetric cipher system during transmission.

In a DTCP system, when accessing an isochronous transmission on the IEEE 1394 bus, a sink device (the recipient of the data) first authenticates with the source device (the holder of the data). During authentication, relevant encryption/decryption keys are obtained or agreed so that the sink device can decode the isochronous transmission upon receipt.

A particular benefit of this system is that encryption occurs at the link layer of the communication stack. Content is therefore available unencrypted above the link layer, making application functions such as trick play and searching much easier to implement than if the data was encrypted.

A copy control system is also incorporated into the DTCP specification. In this manner, content owners can specify how their content can be used (“copy-once,” “copy-never,” etc.). This information is embedded within the content data as copy control information (CCI) and communicated within isochronous transmissions. Onward transmission of content data is limited by the IEEE 1394 bus and IEEE 1394 devices in dependence on CCI status.

The link-layer solution encrypts the link between the two devices and uses embedded copy-control-information (CCI) from the data to determine whether the data needs to be encrypted or indeed can even be transmitted. Data at each end is stored decrypted with the CCI being stored with the data. In this way, communications between devices are secure.

One particular issue with this arrangement is that DTCP is only applied to isochronous streaming and not asynchronous transmissions. One initial reason for this was that asynchronous transmission is not as insecure as isochronous transmission. In addition, no application for asynchronous content transmission was envisaged. New generation devices such as DVD players include digital-out ports. However, this data is only protected if it is transmitted from the digital-out port using DTCP over isochronous delivery. For a portable player, isochronous transfer of data would require streaming in real time by the device.

It is desirable to be able to copy data other than by real time streaming onto the portable player whilst still maintain security. This is particularly applicable to MP3 players and similar digital content storage devices. Asynchronous delivery under the IEEE 1394 bus is a high reliability acknowledged delivery mechanism suitable for transfer of files in non-real time. In comparison, isochronous transmissions are neither acknowledged nor as reliable (relatively speaking). Where real time delivery for immediate rendering is not needed, asynchronous transmission has the advantage of reliability over isochronous transmission. It may be the case in some IEEE 1394 busses that asynchronous transmissions can be compressed for speedier transmission.

According to one aspect of the present invention, there is provided data storage system comprising data storage means for storing data and an asynchronous transmitter/receiver arranged to communicate over an IEEE 1394 network, the data storage means being arranged to accept inputs and to output via an access limiting connector, wherein at least selected data files of the stored data include copy control limiting information, a request for a data file including the copy control limiting information from the data storage means being permitted by the access limiting connector only upon successful authentication, a permitted requested file being encrypted and transmitted asynchronously by the transmitter/receiver.

The present invention seeks to provide an asynchronous communication system offering a secure link between a storage device and some other device in such a way that information delivered to the storage device would be secure on the link as well as whilst on the storage medium.

Preferably, the DTCP algorithm is applied to the asynchronous portion of the IEEE 1394 (1394) bus.

Hardware security requirements on the storage device are addressed by inclusion of an IEEE 1394 connector (typically an IEEE 1394 bridge) as the only physical access means to data stored on the device. Preferably, IEEE 1394 storage devices are used, such as those complying with the Serial Bus Protocol 2, an asynchronous HDD protocol for the IEEE 1394 standard.

This approach secures the link in the same way that DTCP does, providing encryption to the data whilst being transmitted. Data is stored decrypted at both ends, but has to pass through the encryption layer on any device before being transmitted or received. In this manner, only genuine devices are able to gain access to the data stored, with non-encryption-enabled devices being unable to authenticate and therefore access data.

Preferably, the transmitter/receiver operates in accordance with the DTCP specification.

Preferably, the access limiting connector is an IEEE 1394 bridge.

The storage means may comprise a serial bus 2 protocol data storage device.

In one embodiment, an asynchronous data communication system may include a sink and a source, at least the sink incorporating a data storage system as defined above, wherein the source includes authentication and encryption systems arranged to communicate with the data storage system of the sink to facilitate asynchronous encrypted data transfer from the source to the sink.

The asynchronous data communication system may further comprise an intermediate system in communication with the IEEE 1394 network connected to the sink and another network connected to the source, wherein asynchronous data packets transmitted between the source and the sink are transmitted via the intermediate system, the intermediate system including a bridge arranged to convert a received data packet to the appropriate network command set for the destination network prior to onward transmission over the destination network.

The transmitted data files may include a header including copy control information and key change information

According to another aspect of the present invention, there is provided a data storage and transmission method comprising:
storing data in a data storage means arranged to accept inputs and to output via an access limiting connector, wherein at least selected data files of the stored data include copy control limiting information;
permitting a request for a data file including the copy control limiting information from the data storage means only upon successful authentication; and,
encrypting and asynchronously transmitting a requested file upon permitting the request.

The encryption and transmission step may be in accordance with the DTCP specification.

The method may further comprise the step of operating on a first network and accepting communications from a second network wherein an intermediate system bridges the first and second networks, wherein if a request is received from the second network, the step of transmitting a requested file further comprises the step of transmitting to the intermediate system, the intermediate system converting received data to the appropriate network command set for the second network and transmitting the converted data to the second network.

The techniques may be extended over other networks, for example a TCP/IP network.

Also in accordance with the present invention there is provided a method for securing asynchronous data transmitted over a IEEE1394 bus comprising:
requesting a file;
performing authentication and key exchange between sender and receiver of the file, in accordance with the DTCP specification;
generating at least one data packet from the file, each packet comprising:
   a standard header 300 consistent with headers used in DTCP and IEEE 1394 networks;
   a payload header 310 comprising an EMI field 311 used to convey CCI information and an odd/even field 312 used to convey key change notification, which fields are identical to the DTCP specification for isochronous packets; and
   a payload 320 comprising encrypted data, wherein an extension AV/C command is implemented to encrypt the data and map the DTCP security commands;
transmitting each generated data packet asynchronously over the IEEE1394 bus; and
receiving and decrypting each data packet.

An example of the present invention will now be described in detail, with reference to the accompanying drawings in which:

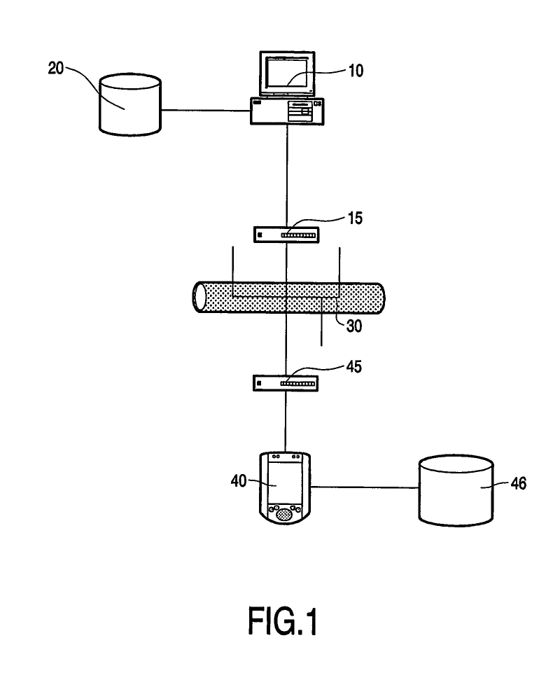

FIG. 1 is a schematic diagram of an asynchronous communication system according to one embodiment of the present invention;

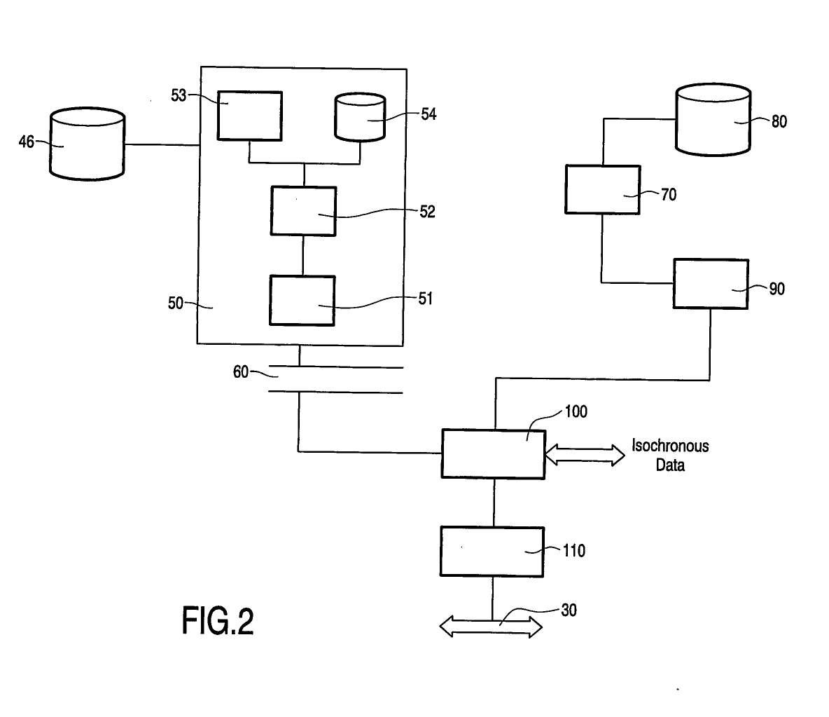

FIG. 2 is a schematic diagram of the sink device of FIG. 1;

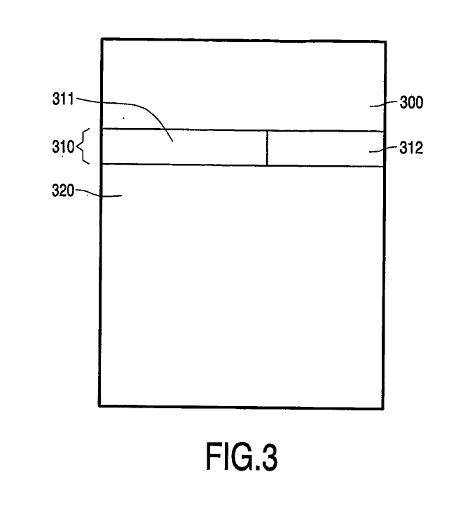

FIG. 3 is a schematic diagram of the format of an asynchronous packet for use in one embodiment of the present invention; and,

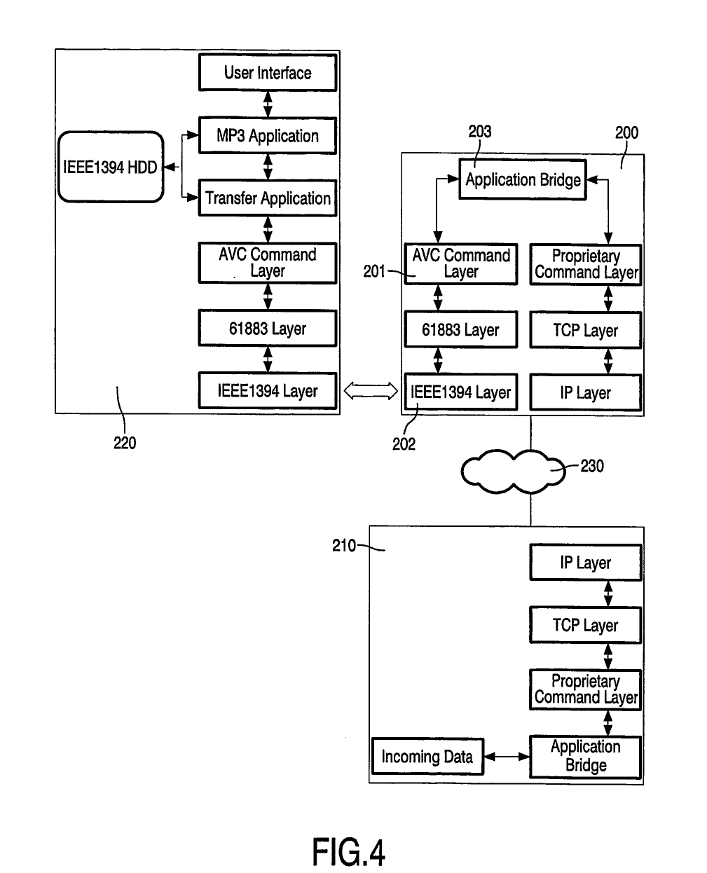

FIG. 4 is a schematic diagram of an extension to the system of FIGS. 1 and 2 in accordance with another embodiment of the present invention.

FIG. 1 is a schematic diagram of an asynchronous communication system according to one embodiment of the present invention.

A source device 10 includes a storage device 20 holding content data such as MP3 encoded audio files, MPEG multimedia files and the like. At the option of the author/originator, the content data may include copy control information (CCI) to limit distribution of the data. The source device 10 is connected to an IEEE 1394 bus 30 via an IEEE 1394 bridge 15.

A sink device 40, such as an MP3 player, includes an IEEE 1394 bridge 45 for connection to the bus 30 and a storage device 46.

Taking as an example, the sink device 40 requesting an MP3 file with some CCI asserted in it. A request for the file is sent to the source device 10. The source device 10 includes an IEEE 1394 chip including the DTCP system, as does the sink device 40. Authentication and key exchange for encryption purposes occurs in the manner described in the DTCP for isochronous transmissions. The MP3 file is packetised, encrypted by the IEEE 1394 chip of the source device 10; according to its CCI status, and then transmitted asynchronously over the bus. At the sink device, the file is received, decrypted and then depacketised. It is then stored decrypted in the storage device 46. Preferably, the storage devices 20 and 46 have an integrated IEEE 1394 bridge including the DTCP system. It is essential that the IEEE 1394 bridge is the only point of data access to the storage device and that no IDE connection or the like is provided.

DTCP is applied to the asynchronous transmissions in a similar manner to that of isochronous transmissions. In order to apply the DTCP to asynchronous transmissions, a payload header containing copy control information and key change information is included in asynchronous packets in addition to the packet header. The payload header is discussed in more detail below with reference to FIG. 3. All other mechanisms, including Authentication and Key Exchange (AKE) are consistent with the current DTCP specification, with the exception that encrypted packets are transmitted asynchronously, not isochronously. In addition, a new extension command for the Audio Video device Command and Control protocol, specified for the IEEE 1394 bus and issued by the 1394 Trade Association (www.1394ta.org) and incorporated herein by reference, is implemented in order to allow encryption of asynchronous packets. The extension is used as a mapping for the DTCP security commands.

Copy control information embedded within the data is used by the devices to limit the copying of files in a manner consistent with the DTCP specification.

A preferred embodiment of the present invention relates to a portable MP3 player that is able to download MP3 files via an IEEE 1394 connection. The device downloads MP3 files from a machine onto a HDD or other storage device via an IEEE 1394 network and/or connection. It can also be plugged into different machines and download files from them. However, should the storage device be removed from the MP3 device, it cannot be accessed by a standard PC or the like due to mechanical incompatibility at the interface. Only devices with appropriate IEEE 1394 connectors and appropriate encryption/decryption systems are able to access data on the device.

To avoid any content protection issues, CCI embedded within the files is used to determine whether the file can be transmitted from the device. Should any MP3s exist which are legitimately free to copy, these can be transferred to other devices. In this manner, the system protects copyrighted material, but allows the transfer of freely distributable MP3s.

FIG. 2 is a schematic diagram of the sink device of FIG. 1.

The device includes the storage device 46 connected via an encryption module 50 to an asynchronous transmission buffer 60. The buffer 60 communicates with the link layer 100 of the IEEE 1394 bridge of the device. The device also includes an AKE system 70 in communication with a certificate store 80 for storing certificate(s) for the device. The AKE system 70 is connected to an AV/C control system 90 which in turn communicates with the link layer 100 of the IEEE 1394 bridge of the device. The link layer 100 communicates with the physical layer 110 which is connected to the physical IEEE 1394 bus 30.

The encryption module 50 includes a scramble/descramble unit 51, a key generator 52, a random number generator 53 and a private key store 54. When files are to be transmitted from the storage device 46, the file is packetised. The key generator 52 obtains the private key from the private key store 54 to generate an encryption key. In practice, the private key is likely to be used with a random number to create a random encryption key. This is then passed to the scramble/descramble unit 51 and used to encrypt the packetised file. The file is then passed to the buffer 60 for asynchronous transmission.

As discussed above, data is decrypted upon receipt and is then passed to the storage device 46 unencrypted. In order to avoid the storage device being placed in an ordinary PC and having its data read with no security preventing this, it is preferred that the only output for data on the storage device 46 is via the IEEE 1394 bridge and its illustrated components herein. It is important to note that the storage device 46 is prevented mechanically from being removed and interrogated on a standard platform such as a PC. Any access to data on the storage device is via the bridge and consequently utilizes the IEEE 1394 and DTCP protocol stack. Where access is requested to data on the storage device, the Authentication and Key Exchange (AKE) procedure, as described in the DTCP specification, is instigated. Only authenticated, encryption enabled, devices would be able to gain access to this data. Inserting the storage device into a normal PC for use as a standard IDE or SCSI hard disk would not be possible due to mechanical incompatibility, and connecting it to a standard IEEE 1394 device (without the encryption system) would result in failure of the AKE.

It will be apparent that encryption cannot occur at the link layer in asynchronous transmission like in isochronous transmissions. DTCP performs the encryption in the link layer and is able to do this due to the provision of Encryption Mode Indicator (EMI) and Odd/Even bits in the isochronous packets. These respectively denote the CCI of the file and when key changes occur. In asynchronous packets, these bits are not available and so have to be added on as an additional header to the payload. In order to achieve this, encryption takes place above the link layer.

FIG. 3 is a schematic diagram of the format of an asynchronous packet for use in one embodiment of the present invention.

The packet includes a standard header 300, a payload header 310 and a payload 320. The standard header 300 is consistent with headers used in DTCP and IEEE 1394 networks. The payload header 310 includes an EMI field 311 used to convey CCI information and an odd/even field 312 used to convey key change notification. The values and usage of the EMI and Odd/Even bit are identical to the DTCP specification for isochronous packets. The payload 320 includes the encrypted packet of data.

FIG. 4 is a schematic diagram of an extension to the system of FIGS. 1 and 2 in accordance with another embodiment of the present invention.

It is also possible to extend the asynchronous encryption link beyond the IEEE 1394 bus. An example application of this would be a secure download application, allowing MP3 files to be downloaded over the internet directly onto the MP3 player, as is illustrated in FIG. 4. In this example, an intermediary such as a host PC 200 sits between the sink device 210 and the source device 220. Messages received by the AV/C layer 201 residing above the 1394 bus 202 in the host PC 200 from the sink device 210 are converted by a bridge 203 into a proprietary command set that are then transmitted over another network, in this example a TCP/IP network 230. This proprietary command set is a direct one to one mapping of the AV/C commands so that they may be forwarded over the other network. Depending on the source and sink, it may be the case the commands and payloads are merely switched from one packet format to another. Authentication and content encryption occur as has been previously described but take place between the source and sink devices 210, 220 respectively. The intermediary PC 200 merely forwards information between the two using a standard IEEE 1394 interface. Downloads could be controlled by software on the intermediary 200 and could then instigate the authentication and transfer protocols between the devices 210, 220. Whilst acting as a middle-man, the intermediary has no means of gaining access to the data due to the encryption of transmitted data between the two devices 210, 220.

The mechanisms by which authentication and encryption is handled at the source device 220 (typically a remote PC) would depend on the hardware being used, but would involve another application bridging from the TCP/IP stack to the target, be it back to AV/C for use on an IEEE 1394 network, or to a standard hard drive interface.

It will be appreciated that one of the many applications of the present invention is in the field of portable media players. One might imagine a scenario of a portable MPEG media player containing a HDD or the like. A DVD could be securely copied onto the media player in accordance with the system of the present invention for subsequent viewing. A device such as this would benefit from being much lighter (having no DVD player) and extended battery life.

1. A data storage system comprising data storage means (46) for storing data and an asynchronous transmitter/receiver (45) arranged to communicate over an IEEE 1394 network (30), the data storage means (46) being arranged to accept inputs and to output via an access limiting connector, wherein at least selected data files of the stored data include copy control limiting information, a request for a data file including the copy control limiting information from the data storage means being permitted by the access limiting connector only upon successful authentication, a permitted requested file being encrypted and transmitted asynchronously by the transmitter/receiver (45).

2. A data storage system according to claim 1, wherein the transmitter/receiver (45) operates in accordance with the DTCP specification.

3. A data storage system according to claim 1 or 2, wherein the access limiting connector is an IEEE 1394 bridge.

4. A data storage system according to claim 1, 2 or 3, wherein the storage means comprises a serial bus 2 protocol data storage device.

5. An MP3 player (40) incorporating the data storage system of any preceding claim.

6. An asynchronous data communication system including a sink (40; 220) and a source (10; 210), at least the sink (40; 220) incorporating a data storage system according to any of claims 1 to 4, wherein the source (10; 210) includes authentication and encryption systems arranged to communicate with the data storage system of the sink to facilitate asynchronous encrypted data transfer from the source (10; 210) to the sink (40; 220).

7. An asynchronous data communication system according to claim 6, further comprising an intermediate system (200) in communication with the IEEE 1394 network connected to the sink (40; 220) and another network (230) connected to the source (10; 210), wherein asynchronous data packets transmitted between the source (10; 210) and the sink (40; 220) are transmitted via the intermediate system (200), the intermediate system (200) including a bridge (203) arranged to convert a received data packet to the appropriate network command set for the destination network prior to onward transmission over the destination network.

8. An asynchronous communication system according to claim 6 or 7, wherein transmitted data files include a header (310) including copy control information and key change information

9. A data storage and transmission method comprising:
storing data in a data storage means arranged to accept inputs and to output via an access limiting connector, wherein at least selected data files of the stored data include copy control limiting information;
permitting a request for a data file including the copy control limiting information from the data storage means only upon successful authentication; and,
encrypting and asynchronously transmitting a requested file upon permitting the request.

10. A data storage and transmission method according to claim 9, wherein the encryption and transmission step is in accordance with the DTCP specification.

11. A data storage and transmission method as claimed in claim 10, wherein the encryption and transmission of the requested file comprises:
generating at least one data packet from the file, each packet comprising:
a standard header 300 consistent with headers used in DTCP and IEEE 1394 networks;
a payload header 310 comprising an EMI field 311 used to convey CCI information and an odd/even field 312 used to convey key change notification, which fields are identical to the DTCP specification for isochronous packets; and
a payload 320 comprising encrypted data, wherein an extension AV/C command is implemented to encrypt the data and map the DTCP security commands; and
transmitting each generated data packet asynchronously over the IEEE1394 bus.

12. A data storage and transmission method according to any of claims 9 to 11, further comprising the step of operating on a first network and accepting communications from a second network wherein an intermediate system bridges the first and second networks, wherein if a request is received from the second network, the step of transmitting a requested file further comprises the step of transmitting to the intermediate system, the intermediate system converting received data to the appropriate network command set for the second network and transmitting the converted data to the second network.

13. A method for securing asynchronous data transmitted over a IEEE1394 bus comprising:
requesting a file;
performing authentication and key exchange between sender and receiver of the file, in accordance with the DTCP specification;
generating at least one data packet from the file, each packet comprising:
a standard header 300 consistent with headers used in DTCP and IEEE 1394 networks;
a payload header 310 comprising an EMI field 311 used to convey CCI information and an odd/even field 312 used to convey key change notification, which fields are identical to the DTCP specification for isochronous packets; and
a payload 320 comprising encrypted data, wherein an extension AV/C command is implemented to encrypt the data and map the DTCP security commands;
transmitting each generated data packet asynchronously over the IEEE1394 bus; and
receiving and decrypting each data packet.
